(19) United States
(12) Patent Application Publication
(10) Pub. No.: US 2020/0363187 A1
(43) Pub. Date: Nov. 19, 2020

(54) LIGHT SENSOR AND COORDINATE MEASURING MACHINE

(71) Applicant: Carl Zeiss Industrielle Messtechnik GmbH, Oberkochen (DE)

(72) Inventor: Nils Haverkamp, Aalen (DE)

(21) Appl. No.: 16/876,033

(22) Filed: May 16, 2020

(30) Foreign Application Priority Data
May 16, 2019 (DE) 10 2019 207 192.9

(51) Int. Cl. G01B 11/00

(52) U.S. Cl. CPC G01B 11/005

(57) ABSTRACT

A light sensor for determining at least two coordinates of a measurement object includes an optical source to generate first and second frequency comb signals, a measurement and a reference detector to detect an input light signal, a coupler, and a photonic integrated circuit to split the first frequency comb signal into first measurement and reference signals and the second frequency comb signal into second measurement and reference signals, guide the first measurement signal to the coupling device to illuminate the measurement object with the first measurement signal, guide the reflected first measurement signal and the second measurement signal to the measurement detector, and guide the first and second reference signals to the reference detector. A signal and data processing unit is provided to evaluate the input light signal and generate frequency spectrums of respective input signals to determine coordinates from a comparison of the frequency spectrums.

### CROSS REFERENCE TO RELATED APPLICATIONS

This application claims priority to German patent application DE 10 2019 207 192.9, filed May 16, 2019, the entire content of which is incorporated herein by reference.

### TECHNICAL FIELD

The disclosure relates to a light sensor for determining at least two coordinates of a measurement object, a coordinate measuring machine and a method for determining two coordinates of a measurement object. The present disclosure relates, in particular, to the field of coordinate measuring technology.

### BACKGROUND

In general, processing and measuring machines require material measures, by which the machines can compare their adopted position with a target position. In general, measuring machines also need to capture features of a test object and quantify these in form and relative position.

While light, as it is non-contact, high resolution and traceable with the least uncertainty, theoretically represents the best of all conceivable alternatives as a material measure, a number of technical problems occur herein, which could be an obstacle to the implementation of light-based metrology in the industrial sector. Problems include, inter alia, the greater outlay in terms of apparatus but nevertheless the low use reliability of the process, for example due to the influence of dirt or beam interruptions.

### SUMMARY

It is therefore an object of the present disclosure to provide a light sensor, a coordinate measuring machine and a method which at least largely avoid the disadvantages of known apparatuses and methods. In particular, dispensing with a material measure should be rendered possible, while simultaneously ensuring highly accurate measuring or positioning.

This object is achieved with a light sensor, a coordinate measuring machine and a method as described herein.

Hereinafter the terms “exhibit”, “have”, “comprise” or “include” or any grammatical deviations therefrom are used in a non-exclusive way. Accordingly, these terms can refer either to situations in which, besides the feature introduced by these terms, no further features are present, or to situations in which one or more further features are present. For example, the expression “A exhibits B”, “A has B”, “A comprises B” or “A includes B” can refer both to the situation in which no further element aside from B is provided in A (that is to say to a situation in which A is composed exclusively of B) and to the situation in which, in addition to B, one or more further elements are provided in A, for example element C, elements C and D, or even further elements.

Furthermore, it is pointed out that the terms “at least one” and “one or more” and grammatical modifications of these terms or similar terms, if they are used in association with one or more elements or features and are intended to express the fact that the element or feature can be provided singly or multiply, in general are used only once, for example when the feature or element is introduced for the first time. When the feature or element is subsequently mentioned again, the corresponding term “at least one” or “one or more” is generally no longer used, without restriction of the possibility that the feature or element can be provided singly or multiply.

Furthermore, hereinafter the terms “typically”, “in particular”, “by way of example” or similar terms are used in conjunction with optional features, without alternative embodiments thereby being restricted. In this regard, features introduced by these terms are optional features, and there is no intention to restrict the scope of protection of the claims, and in particular of the independent claims, by these features. In this regard, the disclosure, as will be recognized by the person skilled in the art, can also be carried out using other configurations. In a similar way, features introduced by “in one embodiment of the disclosure” or by “in one exemplary embodiment of the disclosure” are understood as optional features, without the intention being thereby to restrict alternative configurations or the scope of protection of the independent claims. Furthermore, all possibilities of combining the features introduced by these introductory expressions with other features, whether optional or non-optional features, are intended to remain unaffected by said introductory expressions.

According to a first aspect of the present disclosure, a light sensor for determining at least two coordinates of a measurement object is provided.

The light sensor includes:
a) at least one optical source including at least one dual frequency comb source, wherein the optical source is configured to generate at least one first frequency comb signal and at least one second frequency comb signal;
b) at least one measurement detector and at least one reference detector, each of which are configured to detect at least one input light signal;
c) at least one photonic integrated circuit configured to split the first frequency comb signal into at least one first measurement signal and at least one first reference signal and split the second frequency comb signal into at least one second measurement signal and at least one second reference signal, wherein the photonic integrated circuit is configured to guide the first measurement signal to a coupling device or coupler of the light sensor in order to illuminate the measurement object with the first measurement signal, wherein the coupling device is configured to couple the first measurement signal that was reflected by the measurement object into the photonic integrated circuit, wherein the photonic integrated circuit is configured to guide the reflected first measurement signal and the second measurement signal to the measurement detector, wherein the photonic integrated circuit is configured to guide the first reference signal and the second reference signal to the reference detector; and
d) at least one signal and data processing unit configured to evaluate the respective input light signals detected by the measurement detector and the reference detector and generate at least one frequency spectrum of the respective input signals, wherein at least one coordinate of the measurement object is determinable from a comparison of the frequency spectrum captured by the measurement detector with the frequency spectrum captured by the reference detector.

The light sensor is mounted movably in relation to at least two axes.

A “measurement object” within the scope of the present disclosure can be understood to mean an object to be measured that has any shape. By way of example, the measurement object can be selected from the group consisting of a test object, a workpiece, and a component to be measured.

A “light sensor” can be understood to mean any optical sensor and/or an optical sensor system configured to optically interact with the measurement object and capture a response of the measurement object to the interaction, for example a reflected light beam produced by the measurement object in response to a measurement signal. In the context of the present disclosure, “light” can be understood to mean electromagnetic radiation in at least one spectral range selected from the visible spectral range, the ultraviolet spectral range and the infrared spectral range. The term visible spectral range encompasses, in principle, a range of 380 nm to 780 nm. The term infrared (IR) spectral range encompasses, in principle, a range of 780 nm to 1000 μm, wherein the range of 780 nm to 1.4 μm is designated as near infrared (NIR), and the range of 15 μm to 1000 μm is designated as far infrared (FIR). The term ultraviolet encompasses, in principle, a spectral range of 100 nm to 380 nm. A preferred wavelength range may emerge from the spectral width of the pulse of the employed optical source, for example a mode-coupled laser. This is inversely proportional to the pulse duration. By way of example, a carrier wavelength can range from 1530 nm to 1550 nm, around which sidebands with a width inversely proportional to the pulse length then “group”. Here, the sidebands can be distributed in comb-shaped fashion, in particular equidistantly, in frequency space. The term “light signal” can be understood to mean, as a matter of principle, a quantity of light which is emitted and/or radiated in a specific direction.

Within the scope of the present disclosure, a “coordinate” of a measurement object can be understood to mean a coordinate on a surface to be measured of the measurement object. The light sensor is configured to determine at least two coordinates of the measurement object. The coordinates can be selected from the group consisting of: at least one transverse coordinate of the measurement object, for example an x- and/or y-coordinate, and a longitudinal coordinate, for example at least one vertical coordinate of the measurement object. One or more coordinate systems can be used to determine the at least two coordinates. By way of example, a Cartesian coordinate system or a spherical coordinate system can be used. Other coordinate systems are also conceivable. The light sensor can have an optical axis. The optical axis can be an axis of a coordinate system, for example the z-axis. A vertical coordinate, distance coordinate or a distance can be understood to mean a coordinate along the z-axis. “Determining the at least two coordinates” can be understood to mean measuring and/or detecting and/or recording the at least two coordinates. By way of example, one of the coordinates can be a longitudinal coordinate, in particular information about a distance between a location on the surface of the measurement object and the light sensor. The location can be any location, in particular a point or an area, on the surface to be measured of the measurement object, at which a coordinate is captured. By way of example, a location can be a measurement point on the surface of the measurement object. Further axes, for example x-axis and y-axis and also axes of rotation, can be provided perpendicular to the z-axis.

The light sensor can be configured to determine a plurality of coordinates, in particular 3D information about the measurement object. The light sensor is mounted so as to be movable in relation to at least two axes. Within the scope of the present disclosure, “mounted so as to be movable” can be understood to mean that the light sensor is movable with respect to the measurement of object in relation to at least two axes. By way of example, the light sensor can include at least one bearing unit configured to move the light sensor and/or the light sensor can be introducible in at least one actuator of the coordinate measuring machine, which is configured to move the light sensor. By way of example, the bearing unit can include a rotary swivel device and/or a rotary swivel joint. The light sensor can be mounted so as to be movable in relation to at least five axes, typically six axes. The light sensor can be a three-dimensional light sensor. The light sensor can be a line and/or area sensor. In addition to determining a first coordinate of the measurement object, for example a longitudinal coordinate, being mounted so as to be movable in relation to at least two axes allows at least one further coordinate of the measurement object to be determined following a displacement of the light sensor. This can facilitate a 3D measurement of the measurement object.

An “optical source” can be understood to mean any illumination apparatus which is configured to generate at least one light beam. The light source can include at least one frequency comb generator. A “frequency comb generator” can be understood to mean an apparatus which is configured for at least one frequency measurement. The optical source, in particular the frequency comb generator, includes at least one dual frequency comb source. Within the scope of the present disclosure, a “frequency comb source” can be understood to mean a source, in particular a laser source, which is configured to generate the at least one frequency comb. The frequency comb can have a plurality of modes, which have a substantially constant distance from one another. By way of example, the frequency spacing of the modes can be strictly constant, with phase fluctuations being possible, in the mode-coupled lasers.

The optical source is configured to generate at least one first frequency comb signal and at least one second frequency comb signal. Here, the expressions “first” and “second” provide no information about a sequence or whether further signals are provided. A “frequency comb signal” within the scope of the present disclosure can be understood to mean a light signal comprising a pulse train. The pulse train can have a plurality of pulse repetitions of the frequency comb. Within the scope of the present disclosure, a “dual frequency comb source” can be understood to mean a source which is configured to generate at least two frequency comb signals, in particular simultaneously. The dual frequency comb source can include two integrated continuous wave (cw) laser sources.

The first frequency comb signal and the second frequency comb signal can be dissipative Kerr soliton (DKS) frequency comb signals. The dual frequency comb source can include at least two microresonators, in particular silicon nitride (Si₃N₄) microresonators. The continuous wave (cw) laser sources can be configured to pump the microresonators. The microresonators can be configured to generate the DKS frequency comb signals. Furthermore, the dual frequency comb source can include at least one amplifier, in particular an erbium-doped fibre amplifier.

The first frequency comb signal and the second frequency comb signal can have the same wavelength range or different wavelength ranges. By way of example, the first frequency comb signal and the second frequency comb signal can have frequencies ranging from 150 to 500 THz. By way of example, the first frequency comb signal and the second frequency comb signal can have laser wavelengths around 1300 nm or else around 1100 nm. The first frequency comb signal and the second frequency comb signal can have a spectral overlap, at least in part, such that no beats arise.

Within the scope of the present disclosure, a “measurement detector” can be understood to mean any detector configured to detect an incident input light signal. Within the scope of the present disclosure, a “reference detector” can be understood to mean any detector configured to detect an incident input light signal. The “input light signal” can be understood to be an incident light beam. “Detecting” can be understood to mean capturing and/or recording. The measurement detector and the reference detector can have an identical configuration. By way of example, the measurement detector and the reference detector can each have at least one photodetector. Here, the label “measurement detector” denotes the detector configured to detect a light beam that has been reflected by the measurement object. Here, the label “reference detector” denotes the detector configured to detect at least one reference beam.

The light sensor includes the at least one photonic integrated circuit. A “photonic integrated circuit” can be understood to be an optical system which is configured for communication between components of the circuit with light signals. To this end, the components of the circuit can be arranged on a common substrate, for example a chip, more particularly a microchip. The photonic integrated circuit can include a plurality of light guides, in particular fibre-based light guides. By way of example, the light sensor can have at least one photonic multichip. The multichip can include the optical source, the measurement detector, the reference detector, the photonic integrated circuit and the signal and data processing unit. By way of example, the photonic multichip can be configured as described in “Ultrafast optical ranging using microresonator soliton frequency combs”, P. Trocha et al., Science, RESEARCH REPORTS, 23 Feb. 2018, volume 359, issue 6378. The photonic integrated circuit facilitates a robust, comparatively cheap and compact integration of frequency comb generators in measuring and processing machines.

The photonic integrated circuit is configured to split the first frequency comb signal into the at least one first measurement signal and the at least one first reference signal and split the second frequency comb signal into the at least one second measurement signal and at least one second reference signal. The photonic integrated circuit can include at least one first fibre-based signal splitter, which is configured to split the first frequency comb signal into the first measurement signal and the first reference signal. The photonic integrated circuit can include at least one second fibre-based signal splitter, which is configured to split the second frequency comb signal into the second measurement signal and the second reference signal. The photonic integrated circuit is configured to guide the first measurement signal to the coupling device of the light signal sensor in order to illuminate the measurement object with the first measurement signal. The coupling device is configured to couple the first measurement signal that has been reflected by the measurement object into the photonic integrated circuit. A “coupling device” can be understood to be an apparatus which is configured to input and output couple light signal from the photonic integrated circuit, in particular a light guide of the photonic integrated circuit. The coupling device can include at least one microlens. The microlens can be configured to collimate the first measurement signal to the measurement object.

The photonic integrated circuit is configured to guide the reflected first measurement signal to the measurement detector. To this end, provision can be made of one or more light guides, which are configured to guide the first measurement signal from the coupling device to the measurement detector. The photonic integrated circuit is configured to guide the first reference signal to the reference detector. To this end, one or more light guides can be provided between the first fibre-based signal splitter and the reference detector.

The photonic integrated circuit is configured to guide the second measurement signal to the measurement detector. To this end, one or more light guides can be provided between the second fibre-based signal splitter and the measurement detector. The photonic integrated circuit is configured to guide the second reference signal to the reference detector. To this end, one or more light guides can be provided between the second fibre-based signal splitter and the reference detector.

The measurement detector and the reference detector can be configured to each generate at least one electrical signal in response to the incident light signals. The measurement detector and the reference detector can each have at least one amplifier, which is configured to amplify the electrical signals.

The measurement detector and the reference detector can be configured for a multi-heterodyne detection. The measurement detector can be configured to superpose the first measurement signal and the second measurement signal. This allows a signal, the second measurement signal, with a known spectral intensity profile to be superposed on a signal to be measured, the first measurement signal. The first measurement signal and the second measurement signal can have slightly different frequencies so that so-called “beats” are generated in the case of a superposition of the first measurement signal and the second measurement signal. The reference detector can be configured to superpose the first reference signal and the second reference signal. The first reference signal and the second reference signal can have slightly different frequencies so that beats are generated in the case of a superposition of the first reference signal and the second reference signal. A coordinate of the measurement object, in particular a distance therefrom, can be determined from a comparison of the beat spectra detected with the measurement detector and the reference detector.

The light sensor includes the at least one signal and data processing unit. The signal and data processing unit can include at least one computer or microcontroller, for example. The signal and data processing unit can include one or more volatile and/or non-volatile data memories, wherein the signal and data processing unit can be configured from a programming point of view, for example, to drive the optical source and/or the measurement detector and/or the reference detector. The signal and data processing unit can furthermore include at least one interface, for example an electronic interface and/or a human-machine interface such as, for example, an input/output apparatus such as a display and/or a keyboard and/or an operating console.

The signal and data processing unit is configured to evaluate the input light signals respectively detected by the measurement detector and the reference detector and generate at least one frequency spectrum of the respective input signals. At least one coordinate of the measurement object, in particular a distance between light sensor and measurement object, is determinable from a comparison of the frequency spectrum captured by the measurement detector with the frequency spectrum captured by the reference detector. By changing the alignment of the light sensor along at least one further axis, it is possible to determine further coordinates of the measurement object in the manner described. The signal and data processing unit can include at least one analogue-to-digital converter (ADC), which is configured to receive the electrical signals generated by the measurement detector and the reference detector. The signal and data processing unit can include at least one field programmable gate array (FPGA), which is configured to evaluate the signals received by the ADC.

The light sensor according to the disclosure including a frequency comb generator can facilitate highly accurate positioning of a measuring machine, in particular a coordinate measuring machine. The frequency comb generator facilitates a highly accurate distance measuring system, which can adopt the functions of glass scales or interferometers for measuring the displacement along translation axes with very high measurement accuracies and measurement rates, even at high displacement speeds and displacement accelerations. Compared to the scales, the light sensor according to the disclosure can be advantageous and facilitate a simple traceability, which is practically insensitive to ambient influences, by way of a comparison of the locally employed frequency comb frequencies with a frequency reference, for example an iodine cell. Hence, a traceable uncertainty of 10^{E-8} and less can be available in decentralized fashion, at all times and independently of ambient influences. Compared to interferometric processes, the light sensor according to an aspect of the disclosure can have the advantage of insensitivity toward beam interruptions. The design dependence can relate to the fact that the frequency comb-based methods have a limited uniqueness range, within which the displacement can be measured unambiguously. This uniqueness range can be adapted.

Further, the light sensor according to an aspect of the disclosure can facilitate a highly accurate component measurement, in particular highly accurate sensing at a very high scanning rate, even in the case of a high relative speed of the scanned measurement object. Here, a signal-to-noise (SNR) ratio sufficient for accurate measurements can still be achieved, even in the case of small amounts or relative components of emitted light. Further, the light sensor according to an aspect of the disclosure can be advantageous in relation to confocal and chromatic confocal processes and, in particular, facilitate better accessibility or measurability at arbitrarily inclined surfaces. The light sensor according to an aspect of the disclosure can be advantageous in relation to interferometric processes since the former is capable of carrying out measurements independently of the surface quality of the measurement object in the sensed region. Depending on the design, a significant simplification of the measurement machine structure can be achieved by the omission of the sensor feed spindle and optionally of swivel axes, as well, on account of the large measurement range and the independence of the surface condition of the measurement object.

According to a further aspect of the disclosure, a coordinate measuring machine including at least one light sensor is provided for determining at least two coordinates of a measurement object within the scope of the present disclosure. For details in respect of the coordinate measuring machine, reference is made to the description of the light sensor according to an aspect of the disclosure.

A “coordinate measuring machine” can be understood to mean an apparatus configured to determine the at least two coordinates of the measurement object. The coordinate measuring machine can be an optical coordinate measuring machine. The coordinate measuring machine can be for example a gantry-type measuring machine or a bridge-type measuring machine. The coordinate measuring machine can include a measurement table having at least one bearing surface for bearing the measurement object. The coordinate measuring machine can include at least one gantry which includes at least one first vertical column, at least one second vertical column and a cross beam which connects the first vertical column and the second vertical column. The at least one vertical column selected from the first and second vertical columns can be movable in a horizontal direction on the measurement table. The horizontal direction can be for example a direction along a y-axis. The coordinate measuring machine can have a coordinate system, for example a Cartesian coordinate system or a spherical coordinate system. Other coordinate systems are also conceivable. An origin or zero point of the coordinate system can be defined, for example, by a sensor of the coordinate measuring machine, for example the light sensor. An x-axis can extend perpendicular to the y-axis, in a plane of the bearing surface of the measurement table. A z-axis can extend perpendicular to the plane of the bearing surface, in a vertical direction. The vertical columns can extend along the z-axis. The cross beam can extend along the x-axis.

The coordinate measuring machine includes at least one actuator, which is configured to move the light sensor in relation to at least two axes. Within the scope of the present disclosure, an “actuator” can be understood to mean an apparatus configured in any way, which is configured to move the light sensor in relation to at least two axes. The actuator may include at least one translation actuator, which is configured to move the light sensor along three translation axes. By way of example, the actuator may include at least one rotary swivel bearing, which is configured to move the light sensor along at least one rotational and/or swivel axis. The coordinate measuring machine can be configured to carry out a line and/or area scan.

The coordinate measuring machine can include at least one evaluation unit configured to compare at least one frequency spectrum captured by the measurement detector with at least one frequency spectrum captured by the reference detector and determine at least one coordinate of the measurement object. An “evaluation unit” can be understood to be an apparatus which is configured to evaluate at least one output generated by the light sensor. The evaluation unit can include at least one signal and data processing unit, for example a processor, in particular a microprocessor. The signal and data processing unit of the coordinate measuring machine can be identical to the signal and data processing unit of the light sensor and/or can include a further signal and data processing unit.

According to a further aspect of the disclosure, a method for determining at least two coordinates of a measurement object is provided. At least one light sensor according to an aspect of the disclosure is used within the method. The method includes the following method steps:
i) positioning the light sensor along at least one first axis;
ii) generating at least one first frequency comb signal and at least one second frequency comb signal using at least one optical source, wherein the optical source includes at least one dual frequency comb source;
iii) splitting the first frequency comb signal into at least one first measurement signal and at least one first reference signal using at least one photonic integrated circuit;
iv) splitting the second frequency comb signal into at least one second measurement signal and at least one second reference signal using the at least one photonic integrated circuit;
v) guiding the first measurement signal to a coupling device of the light sensor using the photonic integrated circuit and illuminating the measurement object with the first measurement signal;
vi) coupling the first measurement signal that was reflected by the measurement object into the photonic integrated circuit using the coupling device;
vii) guiding the reflected first measurement signal and the second measurement signal to at least one measurement detector using the photonic integrated circuit;
viii) guiding the first reference signal and the second reference signal to at least one reference detector;
ix) detecting at least one input light signal with, respectively, the measurement detector and the reference detector;
x) evaluating the input light signals respectively detected by the measurement detector and the reference detector using at least one signal and data processing unit, generating at least one frequency spectrum of the respective input signals, comparing the frequency spectrum captured by the measurement detector with the frequency spectrum captured by the reference detector and determining at least one coordinate of the measurement object; and
xi) displacing the light sensor along at least one second axis and determining at least one further coordinate of the measurement object by repeating steps ii) to x).

In this case, the method steps can be carried out in the order specified, wherein one or more of the steps can at least partly also be carried out simultaneously and wherein one or more of the steps can be multiply repeated. Furthermore, further steps can additionally be performed independently of whether or not they are mentioned in the present disclosure. The method can be carried out automatically.

Further, a computer program is provided within the scope of the present disclosure, said computer program, when executed on a computer or computer network, carries out the method according to an aspect of the disclosure, in particular method steps i) to x), in one of its configurations.

Furthermore, a computer program with program code is provided within the scope of the present disclosure, for carrying out the method according to an aspect of the disclosure in one of its configurations when the program is executed on a computer or computer network. In particular, the program code can be stored on a computer-readable data medium.

Moreover, a data medium is provided within the scope of the present disclosure, a data structure being stored on such a data medium, said data structure, after being loaded into a random access memory and/or main memory of a computer or computer network, being configured to carry out the method according to an aspect of the disclosure in one of its configurations.

A computer program product with program code stored on a machine-readable medium is also provided within the scope of the present disclosure, for carrying out the method according to an aspect of the disclosure in one of its configurations when the program is executed on a computer or computer network.

Here, the program is understood to be a commercial product in the context of a computer program product. In principle, it can be available in any form, for example on paper or on a computer-readable data medium, and, in particular, it can be distributed via a data transmission network.

Finally, a modulated data signal is provided within the scope of the present disclosure, said modulated data signal containing instructions that can be executed by a computer system or computer network, for carrying out a method according to any exemplary embodiment described.

In summary, within the scope of the present disclosure, the following exemplary embodiments are provided:

### Exemplary Embodiment 1

Light sensor for determining at least two coordinates of a measurement object, comprising:
a) at least one optical source including at least one dual frequency comb source, wherein the optical source is configured to generate at least one first frequency comb signal and at least one second frequency comb signal;
b) at least one measurement detector and at least one reference detector, each of which are configured to detect at least one input light signal;
c) at least one photonic integrated circuit configured to split the first frequency comb signal into at least one first measurement signal and at least one first reference signal and split the second frequency comb signal into at least one second measurement signal and at least one second reference signal, wherein the photonic integrated circuit is configured to guide the first measurement signal to a coupling device of the light sensor in order to illuminate the measurement object with the first measurement signal, wherein the coupling device is configured to couple the first measurement signal that was reflected by the measurement object into the photonic integrated circuit, wherein the photonic integrated circuit is configured to guide the reflected first measurement signal and the second measurement signal to the measurement detector, wherein the photonic integrated circuit is configured to guide the first reference signal and the second reference signal to the reference detector; and
d) at least one signal and data processing unit configured to evaluate the respective input light signals detected by the measurement detector and the reference detector and generate at least one frequency spectrum of the respective input signals, wherein at least one coordinate of the measurement object is determinable from a comparison of the frequency spectrum captured by the measurement detector with the frequency spectrum captured by the reference detector;
   wherein the light sensor is mounted so as to be movable in relation to at least two axes.

### Exemplary Embodiment 2

Light sensor according to the preceding exemplary embodiment, wherein the light sensor includes at least one photonic multichip, wherein the multichip includes the optical source, the measurement detector, the reference detector, the photonic integrated circuit and the signal and data processing unit.

### Exemplary Embodiment 3

Light sensor according to either of the preceding exemplary embodiments, wherein the light sensor is mounted so as to be movable in relation to at least five axes, typically six axes.

### Exemplary Embodiment 4

Light sensor according to any one of the preceding exemplary embodiments, wherein the measurement detector and the reference detector each include at least one photodetector.

### Exemplary Embodiment 5

Light sensor according to any one of the preceding exemplary embodiments, wherein the first frequency comb signal and the second frequency come signal are dissipative Kerr soliton (DKS) frequency comb signals.

### Exemplary Embodiment 6

Light sensor according to any one of the preceding embodiments, wherein the dual frequency comb source includes two integrated continuous wave (cw) laser sources.

### Exemplary Embodiment 7

Light sensor according to any one of the preceding exemplary embodiments, wherein the dual frequency comb source includes at least two microresonators, in particular silicon nitride (Si₃N₄) microresonators.

### Exemplary Embodiment 8

Light sensor according to any one of the preceding exemplary embodiments, wherein the dual frequency comb source includes at least one amplifier, in particular an erbium-doped fibre amplifier.

### Exemplary Embodiment 9

Light sensor according to any one of the preceding exemplary embodiments, wherein the coupling device includes at least one micro lens.

### Exemplary Embodiment 10

Light sensor according to any one of the preceding exemplary embodiments, wherein the photonic integrated circuit includes a plurality of light guides, in particular fibre-based light guides.

### Exemplary Embodiment 11

Light sensor according to any one of the preceding exemplary embodiments, wherein the photonic integrated circuit includes at least one first fibre-based signal splitter, which is configured to split the first frequency comb signal into the first measurement signal and the first reference signal, wherein the photonic integrated circuit includes at least one second fibre-based signal splitter, which is configured to split the second frequency comb signal into the second measurement signal and the second reference signal.

### Exemplary Embodiment 12

Coordinate measuring machine for determining at least two coordinates of a measurement object, including at least one light sensor according to any one of the preceding exemplary embodiments, wherein the coordinate measuring machine includes at least one actuator configured to move the light sensor along at least two axes.

### Exemplary Embodiment 13

Coordinate measuring machine according to the preceding exemplary embodiment, wherein the coordinate measuring machine includes at least one evaluation unit, which is configured to compare at least one frequency spectrum captured by the measurement detector with at least one frequency spectrum captured by the reference detector and determine at least one coordinate of the measurement object.

### Exemplary Embodiment 14

Coordinate measuring machine according to any one of the preceding exemplary embodiments, wherein the actuator includes at least one translation actuator configured to move the light sensor along three translation axes.

### Exemplary Embodiment 15

Coordinate measuring machine according to any one of the preceding exemplary embodiments, wherein the actuator includes at least one rotary swivel bearing configured to move the light sensor along at least one rotational and/or swivel axis.

### Exemplary Embodiment 16

Coordinate measuring machine according to any one of the preceding exemplary embodiments, wherein the coordinate measuring machine is configured to carry out a line and/or area scan.

### Exemplary Embodiment 17

Method for determining at least two coordinates of a measurement object, wherein at least one light sensor according to any one of the preceding exemplary embodiments relating to a light sensor is used in the method, wherein the method includes the following method steps:
i) positioning the light sensor along at least one first axis;
ii) generating at least one first frequency comb signal and at least one second frequency comb signal using at least one optical source, wherein the optical source includes at least one dual frequency comb source;
iii) splitting the first frequency comb signal into at least one first measurement signal and at least one first reference signal using at least one photonic integrated circuit;
iv) splitting the second frequency comb signal into at least one second measurement signal and at least one second reference signal using the at least one photonic integrated circuit;
v) guiding the first measurement signal to a coupling device of the light sensor using the photonic integrated circuit and illuminating the measurement object with the first measurement signal;
vi) coupling the first measurement signal that was reflected by the measurement object into the photonic integrated circuit using the coupling device;
vii) guiding the reflected first measurement signal and the second measurement signal to at least one measurement detector using the photonic integrated circuit;
viii) guiding the first reference signal and the second reference signal to at least one reference detector;
ix) detecting at least one input light signal with, respectively, the measurement detector and the reference detector;
x) evaluating the input light signals respectively detected by the measurement detector and the reference detector using at least one signal and data processing unit, generating at least one frequency spectrum of the respective input signals, comparing the frequency spectrum captured by the measurement detector with the frequency spectrum captured by the reference detector and determining at least one coordinate of the measurement object; and
xi) displacing the light sensor along at least one second axis and determining at least one further coordinate of the measurement object by repeating steps ii) to x).

### Exemplary Embodiment 18

Method according to the preceding exemplary embodiment, wherein the method is carried out automatically.

### Exemplary Embodiment 19

Computer program which, when executed on a computer or computer network, carries out the method according to the exemplary embodiment 17, in particular method steps i) to x), in one of its configurations.

### Exemplary Embodiment 20

Computer program with program code for carrying out the method according to the exemplary embodiment 17 when the program is executed on a computer or computer network, wherein the program code is stored in a computer readable data medium.

### Exemplary Embodiment 21

Data medium on which a data structure is stored, said data structure, after being loaded into a random access memory and/or main memory of a computer or computer network, being configured to carry out the method according to the exemplary embodiment 17.

### Exemplary Embodiment 22

Computer program product with program code stored on a machine-readable medium for carrying out the method according to the exemplary embodiment 17 when the program is executed on a computer or computer network.

### Exemplary Embodiment 23

A modulated data signal which contains instructions, executable by a computer system or computer network, for carrying out a method according to the exemplary embodiment 17.

### BRIEF DESCRIPTION OF THE DRAWINGS

The disclosure will now be described with reference to the drawings wherein:

FIG. 1 shows a schematic illustration of a light sensor and a coordinate measuring machine according to an exemplary embodiment of the disclosure;

FIG. 2 shows a schematic illustration of a highly accurate component measurement using the light sensor according to an exemplary embodiment of the disclosure; and

FIG. 3 shows a further schematic illustration of the light sensor according to an exemplary embodiment of the disclosure.

### DESCRIPTION OF EXEMPLARY EMBODIMENTS

Further details and features of the disclosure will become apparent from the following description of exemplary embodiments. The respective features can be realized by themselves or as a plurality in combination with one another. The disclosure is not restricted to the exemplary embodiments. The exemplary embodiments are illustrated schematically in the figures. In this case, identical reference numerals in the individual figures designate identical or functionally identical elements or elements corresponding to one another with regard to their functions.

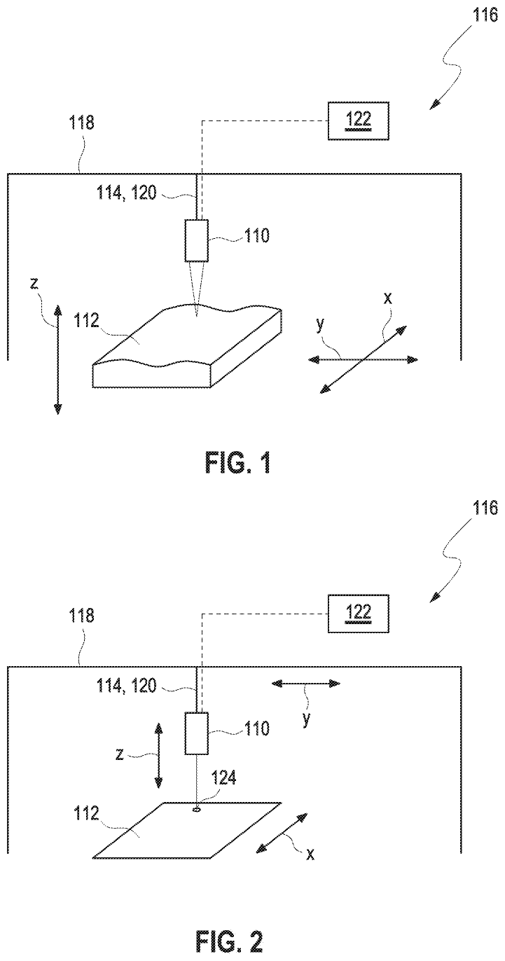

FIG. 1 shows, very schematically, a light sensor 110 according to an exemplary embodiment the disclosure for determining at least two coordinates of a measurement object 112. The measurement object 112 can be an object to be measured of any shape, for example a test object, a workpiece or a component to be measured. The coordinates can be selected from the group consisting of: at least one transverse coordinate of the measurement object 112, for example an x- and/or y-coordinate, and a longitudinal coordinate, for example at least one vertical coordinate of the measurement object 112. The light sensor 110 can be configured to determine a plurality of coordinates, in particular 3D information about the measurement object 112. The light sensor 110 is mounted so as to be movable in relation to at least two axes. By way of example, the light sensor 110 can include at least one bearing unit 114, which is configured to move the light sensor 110. By way of example, the bearing unit 114 can include a rotary swivel device and/or a rotary swivel joint. The light sensor 110 can be mounted so as to be movable in relation to at least five axes, typically six axes. The light sensor 110 can be a three-dimensional light sensor. The light sensor 110 can be a line and/or area sensor. In addition to determining a first coordinate of the measurement object 112, for example a longitudinal coordinate, being mounted so as to be movable in relation to at least two axes allows at least one further coordinate of the measurement object 112 to be determined following a displacement of the light sensor 110. This can facilitate a 3D measurement of the measurement object 112.

FIG. 1 schematically sketches out highly accurate positioning of the light sensor 110 in relation to the measurement object 112 along three possible axes, specifically along the x-, y-, and z-axes, using a coordinate measuring machine 116 according to an exemplary embodiment of the disclosure, which includes the at least one light sensor 110. The coordinate measuring machine 116 can be an optical coordinate measuring machine. The coordinate measuring machine 116 can be for example a gantry-type measuring machine or a bridge-type measuring machine. The coordinate measuring machine 116 can include a measurement table having at least one bearing surface for bearing the measurement object 112. The coordinate measuring machine 116 can have at least one gantry 118 which has at least one first vertical column, at least one second vertical column and a cross beam which connects the first vertical column and the second vertical column. The at least one vertical column selected from the first and second vertical columns can be movable in a horizontal direction on the measurement table. The horizontal direction can be for example a direction along a y-axis. The coordinate measuring machine 116 can have a coordinate system, for example a Cartesian coordinate system or a spherical coordinate system. Other coordinate systems are also conceivable. An origin or zero point of the coordinate system can be defined, for example, by a sensor of the coordinate measuring machine 116, for example the light sensor. An x-axis can extend perpendicular to the y-axis, in a plane of the bearing surface of the measurement table. A z-axis can extend perpendicular to the plane of the bearing surface, in a vertical direction. The vertical columns can extend along the z-axis. The cross beam can extend along the x-axis.

The coordinate measuring machine 116 includes at least one actuator 120, which is configured to move the light sensor 110 in relation to at least two axes. The actuator 120 may include at least one translation actuator, which is configured to move the light sensor along three translation axes. By way of example, the actuator 120 may include at least one rotary swivel bearing configured to move the light sensor along at least one rotational and/or swivel axis. The coordinate measuring machine 116 can be configured to carry out a line and/or area scan.

The coordinate measuring machine 116 can have at least one evaluation unit 122. The evaluation unit 122 can be configured to evaluate output signals, also referred to as output, from the light sensor 110. The evaluation unit 122 can include at least one signal and data processing unit, for example a processor, in particular a microprocessor.

FIG. 2 shows a schematic illustration of a highly accurate component measurement using the light sensor according to the disclosure 110. FIG. 2 shows scanning of the measurement object 112 at a location 124 on the surface of the measurement object 112. The location 124 can be any location, in particular a point or an area, on the surface to be measured of the measurement object 112, at which a coordinate is captured. By way of example, the location 124 can be a measurement point on the surface of the measurement object 112. The light sensor 110 can facilitate highly accurate sensing of the measurement object 112 at a very high scanning rate.

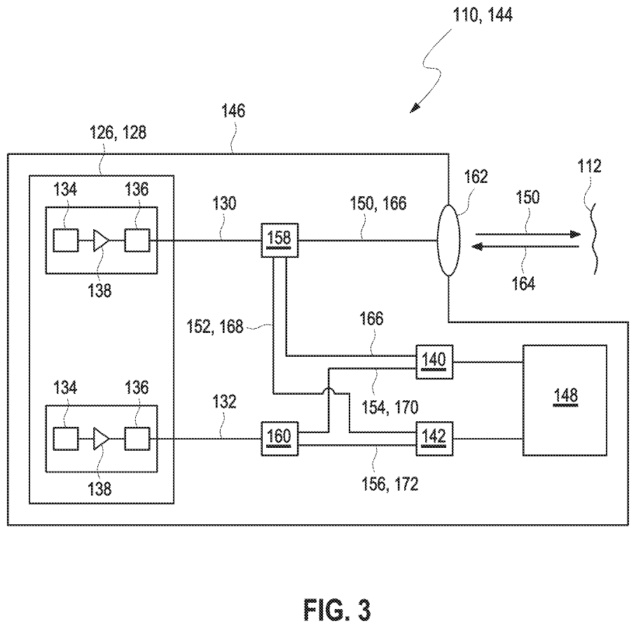

By way of example, the light sensor 110 can be configured as shown in FIG. 3. The light sensor 110 includes at least one optical source 126. The optical source 126 includes at least one dual frequency comb source 128. The dual frequency comb source 126 can be configured to generate at least two frequency combs. The frequency comb can respectively have a plurality of modes, which have a substantially constant distance from one another. By way of example, the frequency spacing of the modes can be strictly constant, with phase fluctuations being possible, in the mode-coupled lasers. The optical source 126 is configured to generate at least one first frequency comb signal 130 and at least one second frequency comb signal 132. The first frequency comb signal 130 and the second frequency comb signal 132 can each have a light signal including a pulse train. The pulse train can have a plurality of pulse repetitions of the frequency comb. The dual frequency comb source 128 can include two integrated continuous wave (cw) laser sources 134. The first frequency comb signal 130 and the second frequency comb signal 132 can be dissipative Kerr soliton (DKS) frequency comb signals. The dual frequency comb source 128 can include at least two microresonators 136, in particular silicon nitride (Si3N4) microresonators. The continuous wave (cw) laser sources 134 can be configured to pump the microresonators 136. The microresonators 136 can be configured to generate the DKS frequency comb signals. Furthermore, the dual frequency comb source 128 can include at least one amplifier 138, in particular an erbium-doped fibre amplifier.

The first frequency comb signal 130 and the second frequency comb signal 132 can have the same wavelength range or different wavelength ranges. By way of example, the first frequency comb signal 130 and the second frequency comb signal 132 can have frequencies ranging from 150 to 500 THz. By way of example, the first frequency comb signal and the second frequency comb signal can have laser wavelengths around 1300 nm or else around 1100 nm. The first frequency comb signal and the second frequency comb signal can have a spectral overlap, at least in part, such that no beats arise.

The light sensor 110 further includes at least one measurement detector 140 and at least one reference detector 142, each of which are configured to detect at least one input light signal. By way of example, the measurement detector 140 and the reference detector 142 can each have at least one photodetector.

The light sensor 110 includes the at least one photonic integrated circuit 144. The photonic integrated circuit 144 can be configured for communication between the components of the circuit 144 with light signals. To this end, the components of the circuit 144 can be arranged on a common substrate 146, for example a chip, more particularly a microchip. The photonic integrated circuit 144 can include a plurality of light guides, in particular fibre-based light guides. By way of example, the light sensor 110 can have at least one photonic multichip. The multichip can include the optical source 126, the measurement detector 140, the reference detector 142, the photonic integrated circuit 144 and a signal and data processing unit 148. By way of example, the photonic multichip can be configured as described in “Ultrafast optical ranging using microresonator soliton frequency combs”, P. Trocha et al., Science, RESEARCH REPORTS, 23 Feb. 2018, volume 359, issue 6378. The photonic integrated circuit 144 facilitates a robust, comparatively cheap and compact integration of frequency comb generators in measuring and processing machines.

The photonic integrated circuit 144 is configured to split the first frequency comb signal 130 into at least one first measurement signal 150 and at least one first reference signal 152 and split the second frequency comb signal 132 into at least one second measurement signal 154 and at least one second reference signal 156. The photonic integrated circuit 144 can include at least one first fibre-based signal splitter 158, which is configured to split the first frequency comb signal 130 into the first measurement signal 150 and the first reference signal 152. The photonic integrated circuit 144 can include at least one second fibre-based signal splitter 160, which is configured to split the second frequency comb signal 132 into the second measurement signal 154 and the second reference signal 156. The photonic integrated circuit 144 is configured to guide the first measurement signal 150 to a coupling device 162 of the light sensor 110 in order to illuminate the measurement object 112 with the first measurement signal 150. The coupling device 162 is configured to couple the first measurement signal 164 that has been reflected by the measurement object 112 into the photonic integrated circuit 144. The coupling device 162 can include at least one microlens. The microlens can be configured to collimate the first measurement signal 150 to the measurement object 112.

The photonic integrated circuit 144 is configured to guide the reflected first measurement signal 164 to the measurement detector 140. To this end, provision can be made of one or more light guides, which are configured to guide the first measurement signal 150 from the coupling device 162 to the measurement detector 140. The photonic integrated circuit 144 is configured to guide the first reference signal 152 to the reference detector 142. To this end, one or more light guides 168 can be provided between the first fibre-based signal splitter 158 and the reference detector 142.

The photonic integrated circuit 144 is configured to guide the second measurement signal 154 to the measurement detector 140. To this end, one or more light guides 170 can be provided between the second fibre-based signal splitter 160 and the measurement detector 140. The photonic integrated circuit 144 is configured to guide the second reference signal 156 to the reference detector 142. To this end, one or more light guides 172 can be provided between the second fibre-based signal splitter 160 and the reference detector 142.

The measurement detector 140 and the reference detector 142 can be configured to each generate at least one electrical signal in response to the incident light signals. The measurement detector 140 and the reference detector 142 can each have at least one amplifier, which is configured to amplify the electrical signals.

The measurement detector 140 and the reference detector 142 can be configured for a multi-heterodyne detection. The measurement detector 140 can be configured to superpose the first measurement signal 150 and the second measurement signal 154. This allows a signal, the second measurement signal 154, with a known spectral intensity profile to be superposed on a signal to be measured, the first measurement signal 150. The first measurement signal 150 and the second measurement signal 154 can have slightly different frequencies so that so-called “beats” are generated in the case of a superposition of the first measurement signal and the second measurement signal. The reference detector 142 can be configured to superpose the first reference signal 152 and the second reference signal 156. The first reference signal 152 and the second reference signal 156 can have slightly different frequencies so that beats are generated in the case of a superposition of the first reference signal and the second reference signal. A coordinate of the measurement object 112, in particular a distance therefrom, can be determined from a comparison of the beat spectra detected with the measurement detector 140 and the reference detector 142.

The light sensor 110 includes the at least one signal and data processing unit 148. The signal and data processing unit 148 can include at least one computer or microcontroller, for example. The signal and data processing unit 148 can include one or more volatile and/or non-volatile data memories, wherein the signal and data processing unit 148 can be configured from a programming point of view, for example, to drive the optical source 126 and/or the measurement detector 140 and/or the reference detector 142. The signal and data processing unit 148 can furthermore include at least one interface, for example an electronic interface and/or a human-machine interface such as, for example, an input/output apparatus such as a display and/or a keyboard and/or an operating console.

The signal and data processing unit 148 is configured to evaluate the input light signals respectively detected by the measurement detector 140 and the reference detector 142 and generate at least one frequency spectrum of the respective input signals. At least one coordinate of the measurement object 112, in particular a distance between light sensor 110 and measurement object 112, is determinable from a comparison of the frequency spectrum captured by the measurement detector 140 with the frequency spectrum captured by the reference detector 142. By changing the alignment of the light sensor 110 along at least one further axis, it is possible to determine further coordinates of the measurement object 112 in the manner described. The signal and data processing unit 148 can include at least one analogue-to-digital converter (ADC), which is configured to receive the electrical signals generated by the measurement detector 140 and the reference detector 142. The signal and data processing unit 148 can include at least one field programmable gate array (FPGA), which is configured to evaluate the signals received by the ADC.

It is understood that the foregoing description is that of the exemplary embodiments of the disclosure and that various changes and modifications may be made thereto without departing from the spirit and scope of the disclosure as defined in the appended claims.

### LIST OF REFERENCE NUMERALS

110 Light sensor
112 Measurement object
114 Bearing unit
116 Coordinate measuring machine
118 Gantry
120 Actuator
122 Evaluation unit
124 Location
126 Optical source
128 Dual frequency comb source
130 1st frequency comb signal
132 2nd frequency comb signal
134 CW laser source
136 Microresonators
138 Amplifier
140 Measurement detector
142 Reference detector
144 Photonic integrated circuit
146 Substrate, photonic multichip
148 Signal and data processing unit
150 1st measurement signal
152 1st reference signal
154 2nd measurement signal
156 2nd reference signal
158 1st fibre-based signal splitter
160 2nd fibre-based signal splitter
162 Coupling device
164 Reflected first measurement signal
166 Light guide
168 Light guide
170 Light guide
172 Light guide

What is claimed is:

1. A light sensor for determining at least two coordinates of a measurement object, the light sensor comprising:
an optical source including a dual frequency comb source and being configured to generate a first frequency comb signal and a second frequency comb signal;
a measurement detector configured to detect an input light signal;
a reference detector configured to detect the input light signal;
a coupling device;
a photonic integrated circuit configured to:
split the first frequency comb signal into a first measurement signal and a first reference signal,
split the second frequency comb signal into a second measurement signal and a second reference signal,
guide the first measurement signal to the coupling device to illuminate the measurement object with the first measurement signal, the coupling device being configured to couple the first measurement signal reflected by the measurement object into the photonic integrated circuit,
guide the first measurement signal and the second measurement signal to the measurement detector, and
guide the first reference signal and the second reference signal to the reference detector;
a signal and data processing unit configured to:
evaluate the input light signal detected by the measurement detector and detected by the reference detector, and
generate at least one frequency spectrum of the respective input signals,
wherein at least one coordinate of the measurement object is determinable from a comparison of a frequency spectrum captured by the measurement detector with the frequency spectrum captured by the reference detector, and
wherein the light sensor is mounted movably in relation to at least two axes.

2. The light sensor according to claim 1, further comprising:
a photonic multichip including the optical source, the measurement detector, the reference detector, the photonic integrated circuit, and the signal and data processing unit.

3. The light sensor according to claim 1, wherein the light sensor is mounted movably relative to at least five axes.

4. The light sensor according to claim 1, wherein the light sensor is mounted movably relative to six axes.

5. The light sensor according to claim 1, wherein the first frequency comb signal and the second frequency comb signal are dissipative Kerr soliton frequency comb signals.

6. The light sensor according to claim 1, wherein the photonic integrated circuit comprises:
a plurality of light guides;
a first fibre-based signal splitter configured to split the first frequency comb signal into the first measurement signal and the first reference signal; and
a second fibre-based signal splitter configured to split the second frequency comb signal into the second measurement signal and the second reference signal.

7. A coordinate measuring machine for determining the at least two coordinates of the measurement object, the coordinate measuring machine comprising:
a light sensor according to claim 1; and
an actuator configured to move the light sensor along the at least two axes.

8. The coordinate measuring machine according to claim 7, further comprising:
an evaluation unit configured to:
compare the at least one frequency spectrum captured by the measurement detector with the at least one frequency spectrum captured by the reference detector, and
determine the at least one coordinate of the measurement object.

9. A method for determining the at least two coordinates of the measurement object with the light sensor according to claim 1, the method comprising:
(i) positioning the light sensor along a first axis;
(ii) generating the first frequency comb signal and the second frequency comb signal with the optical source, the optical source including the dual frequency comb source;
(iii) splitting the first frequency comb signal into the first measurement signal and the first reference signal with the photonic integrated circuit;
(iv) splitting the second frequency comb signal into the second measurement signal and the second reference signal with the photonic integrated circuit;
(v) guiding the first measurement signal to the coupling device of the light sensor with the photonic integrated circuit and illuminating the measurement object with the first measurement signal;
(vi) coupling the first measurement signal reflected by the measurement object into the photonic integrated circuit with the coupling device;
(vii) guiding the first measurement signal and the second measurement signal to the measurement detector with the photonic integrated circuit;
(viii) guiding the first reference signal and the second reference signal to the reference detector;
(ix) detecting the input light signal with the measurement detector and the reference detector;
(x) evaluating input light signals respectively detected with the measurement detector and the reference detector with the signal and data processing unit, generating the frequency spectrum of the input signals, comparing the frequency spectrum captured by the measurement detector with the frequency spectrum captured by the reference detector and determining the at least one coordinate of the measurement object; and
(xi) displacing the light sensor along a second axis and determining a further coordinate of the measurement object by repeating steps (ii) to (x).

10. A computer program which, when executed on a computer or a computer network, carries out the method according to claim 9.

11. A non-transitory computer-readable storage medium encoded with program code comprising computer-executable instructions and when the program code is executed on a computer or a computer network operable to carry out the method according to claim 9.
